(19) United States
(12) Patent Application Publication
(10) Pub. No.: US 2007/0138752 A1
(43) Pub. Date: Jun. 21, 2007

(54) Tool sledge

(76) Inventors: Monte E. Kress, Longview, WA (US); Tim Wesley Shay, Kelso, WA (US)

Correspondence Address: K.M. RYLANDER;RYLANDER & ASSOCIATES, 406 West 12th Street, Vancouver, WA, 98660, US

(21) Appl. No.: 11/305,083

(22) Filed: Dec. 16, 2005

(51) Int. Cl. B62B 15/00

(52) U.S. Cl. 280/19; 280/28.12

(57) ABSTRACT

A tool sledge includes a bottom runner, upturned ends, and sidewalls, an adhering portion affixed to the top of said bottom runner, a circular recess in the top of said bottom runner, and a pull.

### FIELD OF THE INVENTION

This invention relates generally to the field of sledges for transporting tools at construction sites.

### BACKGROUND

A construction worker must transport an assortment of tools and supplies from one part of the construction site to another. Transportation frequently includes the need to cross open framing exposed to a room below. While working on a construction project, the worker may need ready access to a multitude of tools and supplies, such as: hammers, screwdrivers, drills, saws, measuring tape, buckets, paint cans, brushes, and nails, among others. An existing problem for construction workers is how to quickly and safely transport these tools and supplies from one place to another within the same construction site.

Previously, the construction worker could wear a tool belt, carry a tool case, or carry by hand necessary tools and supplies. These methods put physical strain on the construction worker in the manifestation of back, shoulder, and/or neck pain. Additionally, carrying the tools and supplies increases the likelihood of accidents and the number of resulting injuries due to dropping the tools and supplies. These methods also greatly limited both the number and weight of tools and supplies that the construction worker could carry at one time.

The following represents a list of known related art:

| Reference: | Issued to: | Date of issue: |
|---|---|---|
| U.S. Pat. No. 6,926,293 | Pope | Aug. 9, 2005 |
| U.S. Pat. No. 5,653,455 | Richards | Aug. 5, 1997 |
| U.S. Pat. No. 4,533,150 | Hardy | Aug. 6, 1985 |
| U.S. Pat. No. 1,665,449 | Drake | Apr. 10, 1928 |
| U.S. Pat. No. 715,572 | Gregg | Dec. 9, 1902 |

The teachings of each of the above-listed citations (which do not themselves incorporate essential material by reference) are herein incorporated by reference. None of the above inventions and patents, taken either singularly or in combination, is seen to describe the instant invention as claimed.

### SUMMARY AND ADVANTAGES

A tool sledge is provided to transport construction tools and supplies. A tool sledge includes bottom runners, upturned ends, and sidewalls, one or more tool adhering portions affixed to and running along the top of said bottom runners, a circular recess in the top of said bottom runners, and one or more pulls.

The tool sledge of the present invention presents numerous advantages, including: (1) facilitating transport of numerous tools and supplies from one part of a construction site to another, (2) facilitating transport of tools and supplies over open framing exposed to rooms below, (3) facilitating transport of heavy tools and supplies, and (4) securing tools and supplies during transport to avoid accidents.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows a perspective view of an embodiment of the present invention in use.

FIG. 2 shows a top view of the detail of the embodiment of FIG. 1.

FIG. 3 shows a side view of another detail of the embodiment in FIG. 1.

FIG. 4 shows another perspective view of the embodiment of FIG. 1.

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

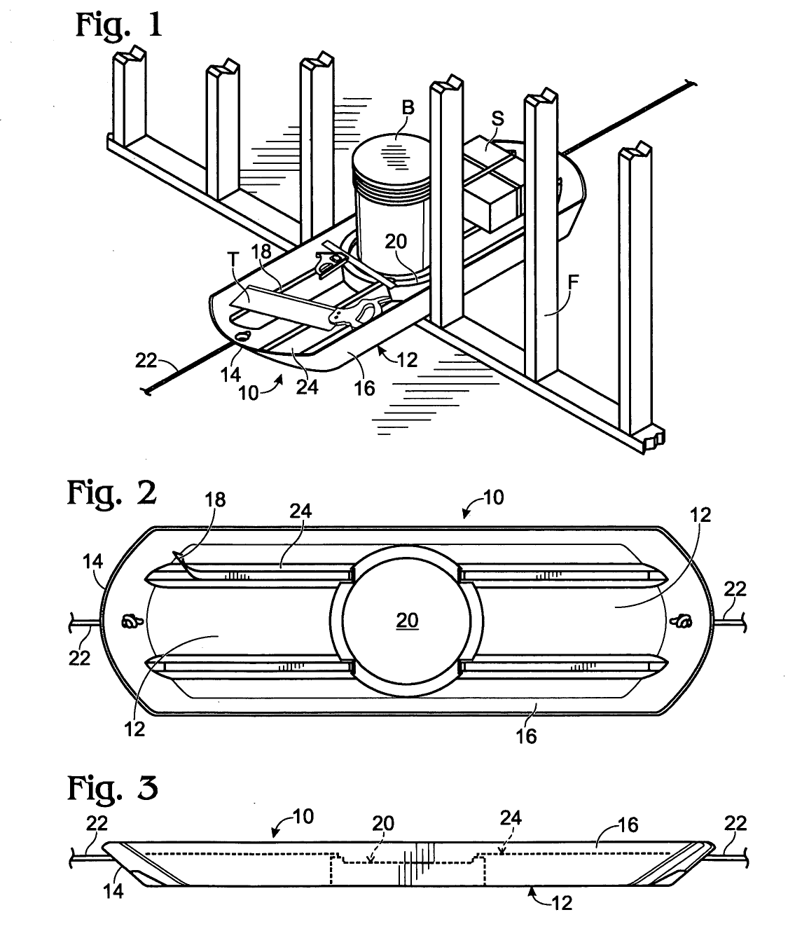

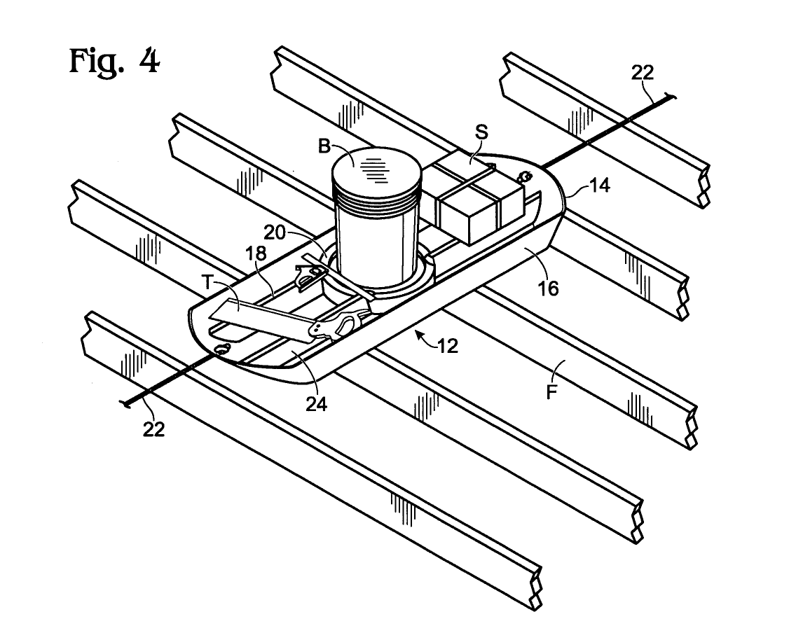

A tool sledge is provided to transport tools and supplies within a construction site. As shown in FIGS. 1-4, a tool sledge 10 includes a bottom runner 12, upturned ends 14, and sidewalls 16, a tool adhering portion 18 affixed to and running along the top of said bottom runner 12, a circular recess 20 in the top of said bottom runner, and a pull 22 attached to said sledge portion.

Tool sledge 10 is preferably rectangular in shape with an elongated substantially flat bottom runner 12, rounded upturned ends 14 and sidewalls 16 which form parallel sides of the sledge and join continuously to the upturned ends 14. Bottom runner 12, upturned ends 14 and sidewalls 16 define an upwardly opening hollow sledge body with a backwardly and upwardly sloping rear wall, a forwardly and upwardly sloping front wall, upstanding side walls, and a generally planar bottom.

Sledge 10 width is sized to fit between standard construction framing F and bottom runner 12 is between 12 inches and 24 inches (30.48 cm and 60.96 cm) in width, preferably 14 inches (35.56 cm) in width. Sledge 10 length and wide is sized to fit over exposed framing F, and bottom runner 12 is between 2 feet and 6 feet (0.61 m and 1.83 m) in length, preferably 4 feet (1.22 m) in length so that the tool sledge 10 can pass over frame flooring F without falling between the exposed beams.

As shown in FIGS. 1-4, the bottom runner 12 can be divided into two or more runners by forming channels 24 in the bottom runner 12. Preferably channels 24 run lengthwise from upturned ends 14 to the center recess 20. Preferably the tops of the channels 24 are flat. In the preferred embodiment, the bottom runner 12 is split into three runners by two channels 24 projecting upward. 12.

Adhering portions 18 are affixed to the bottom runner on the inside of the sledge. Preferably adhering portions 18 are magnetic strips glued to the top of said bottom runner 12 which can removably anchor tools T or supplies S during transport. Where the bottom runner 12 is divided into two more runners by channels 24 formed in the bottom runner 12, the adhering portions 18 are preferably glued to the tops of said channels 24, as shown in FIG. 2.

As shown in FIGS. 1-4, circular recess 20 is preferably formed on top of sledge bottom runner 12 and preferably divides channels 24 between upturned ends 14 of the tool sledge 10. Circular recess 20 is sized to fit the base of a cylinder, such as the bottom of a five gallon bucket B, snugly fit within the circular recess 20. Preferably, circular recess 20 fits a 10½ inch (26.67 cm) diameter cylinder base B. Circular recess 20 stabilizes a cylinder B during transport. Channels 24 which are divided by circular recess 20 can be of greater height than the recess to assist in stabilizing the cylinder B during transport.

Preferably, circular recess 20 is formed out of the bottom of the sledge 10 and is centered in the tool sledge 10 top, breaking into two halves the top of the channels 24 formed out of the bottom of the tool sledge 10.

In the preferred embodiment, the tool sledge 10, except for the pulls 22 and adhering portions 18, is made out of a single mold, having a bottom runner 12 split into three runner, the three runners defined and separated by two channels 24 which extend upward. Preferably, tool sledge 10, except for pulls 22 and adhering portions 18, is made of a durable plastic material to withstand friction with the surface over which it is being pulled during use. Preferably, the tool sledge 10 is comprised of vacuum formable material, available in sheet form. A high molecular weight polyethylene plastic, for example, is very suitable. It is very workable and strong, so that fastening parts together using bolts in threaded or unthreaded bores is very practical. Sledge 10 can also be made of fiberglass, metal, or other material able light enough to pull and able to hold its shape while transporting tools T and supplies S across open framing F.

Pulls 22 are preferably ropes attached to upturned ends 14 of tool sledge 10, allowing the user to pull the tool sledge 10 from the front or the rear. Preferably, pull is a rope that is threaded through a hole in either upturned end and attached to it by knotting. Those with skill in the art recognize that pull 22 can be a variety of articles including rods straps, handles, bars, poles, and can be attached to the tool sledge body in a number of ways, at the upturned ends, at the sidewalls, by knotting, hooks, rings, loops, slits, links, screws, nails, adhesive substances, bolts, clamps, rivets, and hinges. The preferred pull 22 length is 5 feet (1.52 m) which is of sufficient length to allow the tool sledge user to walk upright while holding onto the pull 22, thus pull the tool sledge 10 carrying tools T and supplies S, and a cylinder B behind him or her to another location at the construction site.

In use, the construction worker lays his tools T, such as a saw or a hammer, on the channels 24 in the tool sledge 10 and they are removably attached to the tool sledge 10 by the adhering portions 18. The worker puts a five gallon bucket B into the circular recess 20. Bucket B can hold nails, plaster, paint, or other volumetric construction supply item. Worker grabs a pull 22 and moves through the worksite and the size of the tool sledge 10 allows it to pass through the framed but unfinished walls and over framed but unfinished flooring which is exposed to the room below.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

We claim:

1. A tool sledge, comprising:
A bottom runner;
Upturned ends extending from said bottom runner;
Sidewalls joined to said bottom runner and said upturned ends;
An adhering portion affixed the top of said bottom runner;
A circular recess in the top of said bottom runner; and
A pull attached to an upturned end.

2. A tool sledge, comprising:
a upwardly opening hollow sledge body with a backwardly and upwardly sloping rear wall, a forwardly and upwardly sloping front wall, upstanding side walls, and a generally planar bottom runner;
at least one raised bar integral with the bottom runner;
an one or more adhering portions secured to the top face of each said raised bar;
one or more circular recesses integral with said bottom runner; and
one or more pulls attached to said sledge body such that the user can walk upright while pulling said tool sledge.

3. The sledge of claims 1 or 2, wherein the circular recess snugly holds the base of a five gallon bucket.

4. The sledge of claims 1 or 2, wherein the circular recess as an interior diameter of 10½ inches (26.67 cm).

5. The sledge of claims 1 or 2, wherein said adhering portions are magnetic strips.

6. The sledge of claims 1 or 2, wherein said bottom runner has a length, between 2 feet and 6 feet (0.61 m and 1.83 m)

7. The sledge of claims 1 or 2, wherein said bottom runner is 4 feet (1.22 m) long.

8. The sledge of claims 1 or 2, wherein said bottom runner has a width between 12 inches and 24 inches (30.48 cm and 60.96 cm).

9. The sledge of claims 1 or 2, wherein said bottom runner is 14 inches (35.56 cm) wide.

10. The sledge of claims 1 or 2, wherein said bottom runner has a length of between 2 feet and 6 feet (0.61 m and 1.83 m) and a width between 12 inches and 24 inches (30.48 cm and 60.96 cm).

11. The sledge of claims 1 or 2, wherein said bottom runner is 4 feet (1.22 m) long and 14 inches (35.56 cm) wide.

12. A tool sledge, comprising:
a sledge portion;
means for adhering tools attached to said sledge portion;
circular means for holding cylindrical containers form in said sledge portion; and
pulling means attached to said sledge portion.

13. The sledge of claim 12, wherein the circular recess snugly holds the base of a five gallon (bucket.

14. The sledge of claim 12, wherein the circular basis as an interior diameter of 10½ inches (26.67 cm).

15. The sledge of claim 12, wherein said adhering portions are magnetic strips.

16. The sledge of claim 12, wherein said bottom runner has a length, between 2 feet and 6 feet (0.61 m and 1.83 m).

17. The sledge of claim 12, wherein said bottom runner is 4 feet (1.22 m) long.

18. The sledge of claim 12, wherein said bottom runner has a width between 12 inches and 24 inches (30.48 cm and 60.96 cm).

19. The sledge of claim 12, wherein said bottom runner is 14 inches (35.56 cm) wide.

20. The sledge of claim 12, wherein said bottom runner has a length of between 2 feet and 6 feet (0.61 m and 1.83 m) and a width between 12 inches and 24 inches (30.48 cm and 60.96 cm).

21. The sledge of claims 1 or 2, wherein said bottom runner is 4 feet (1.22 m) long and 14 inches (35.56 cm) wide.
